(19) United States
(12) Patent Application Publication
(10) Pub. No.: US 2005/0034084 A1
(43) Pub. Date: Feb. 10, 2005

(54) Mobile terminal device and image display method

(76) Inventors: Toshikazu Ohtsuki, Osaka-shi (JP); Katsunori Orimoto, Neyagawa-shi (JP); Toshiki Hijiri, Hirakata-shi (JP); Akira Uesaki, Takatsuki-shi (JP); Yoshiyuki Mochizuki, Suita-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/909,307

(22) Filed: Aug. 3, 2004

(30) Foreign Application Priority Data
Aug. 4, 2003 (JP) 2003-286005

(51) Int. Cl. G09G 5/00

(52) U.S. Cl. 715/864; 715/784; 715/785; 715/713; 715/738; 715/838; 715/841; 715/810; 715/776

(57) ABSTRACT

A mobile terminal device 100 comprises an object unit 100a operable to generate and store various kinds of objects composed of three-dimensional objects, a database unit 100b operable to store information displayed for the three-dimensional objects, a key input unit 100c operable to perform input processing by input keys such as cursor keys, a rendering unit 100d operable to render various kinds of objects passed by the object unit 100a based on the position information and a display unit 100e operable to generate and display images to be displayed on the display screen.

### BACKGROUND OF THE INVENTION

(1) Field of the Invention

The present invention relates to a mobile terminal device such as a mobile phone and a PDA that displays digital images or digital moving images, and particularly to a mobile terminal device that generates objects using a three-dimensional display technique and displays them on a small screen.

(2) Description of the Related Art

As digital cameras and video cameras have been popular recently, the numbers of digital images and videos that are owned personally increase. Also, as most models of recent mobile phones have a digital camera function, and a large number of image shots taken by a user are stored in a mobile phone. In this situation, there remains a challenge of how to select and use a large number of the digital image shots shot by a user and stored in the terminal device.

As use of digital images, there are applications, for example, storing a series of related images in an album, modifying the face of a subject in a photograph, so-called Purikura (instant digital photo sticker where a shot digital image is combined with one of preset frames) or the like. A digital image shot to be used must be selected from a large number of digital image shots also in the case of using these applications of digital images.

A popular image display method for PCs, mobile phones, PDAs, cameras with a monitor and the like is the thumbnail image display method where a plurality of digital images are scaled down and displayed on a display screen so as to enable users to look through a large number of digital images and select a favorite image shot.

As a display method generated by three-dimensionally extending the thumbnail image display method, a medium on which a three-dimensional display processing device, method and control program are recorded is disclosed (refer to Patent Literature 1, Japanese Laid-Open Patent application No. 11-231993 as an example). This three-dimensional display device enables users to walk through the three-dimensional space and compares input data by placing pieces of input data with an evaluation value in the three-dimensional space as display images that can be displayed all together.

However, in the case where a user displays a large number of digital image shots on a small display screen of a mobile phone for which the above-mentioned conventional thumbnail image display method is used, the user must take the trouble to scroll a display screen frequently and switch display screens because a large area is needed for displaying those digital image shots although there is a restriction on the size of the display screen. Therefore, using the thumbnail display method for a small display screen of the mobile terminal device or the like brings a problem that the method requires more frequent user operation.

In addition, as digital image shots are scaled down and displayed on a display screen basically in time sequence in the conventional thumbnail image display method, a user has difficulty in grasping a relation among a lot of images and a time relation such as “date and time” and “day and night”. Also, a user needs to switch display screens so as to search information concerning a specific image. The thumbnail display method also has a problem that a user has difficulty in searching a favorite image because of the difficulty, as mentioned above, in grasping various kinds of complex information corresponding to each of the large number of digital images.

### SUMMARY OF THE INVENTION

The first object of the present invention determined considering those problems is to provide mobile terminal devices with improved userfriendliness in searching images, looking through pieces of information by displaying pieces of information concerning larger number of images on a small display screen of a mobile terminal device in a userfriendly manner.

The second object is to provide mobile terminal devices that enable a user to display images and various kinds of corresponding related information in an easy-to-grasp manner, and select a favorite image without switching display screens. Further, the third object is to provide mobile terminal devices where a display method with a more enjoyable operational manner by displaying images on the display screen of a mobile terminal device more beautifully.

In order to solve those problems, the mobile terminal device concerning the present invention comprising: an object generation unit operable to generate an object; a texture generation unit operable to generate a second texture image for a piece of related information relating to a first texture image; a texture mapping unit operable to map the first texture image, and the second texture image generated by the texture generation unit, onto the object generated by the object generation unit so as to generate an image object; a block generation unit operable to generate a block object by placing a plurality of image objects in three-dimensional space based on corresponding pieces of related information so as to generate a block object; an image generation unit operable to generate an image of the block object; and a display unit operable to display the image generated by the image generation unit.

Also, the object generation unit of the mobile terminal device concerning the present invention generates a three-dimensional object, the texture mapping unit generates image objects by mapping the first texture image onto front surfaces of the three-dimensional object, the second texture image onto a side surface of the three-dimensional objects, the block generation unit generates a block object by placing the plurality of the image objects based on the pieces of related information so that the image objects construct a polyhedron in the three-dimensional space, the image generation unit generates images of the block object, and the display unit displays the images.

Therefore, it is possible to generate three-dimensional objects on the display screen of a mobile terminal device using computer graphics technique, display a plurality of images and the corresponding various kinds of pieces of information on a small display screen of the mobile terminal in an easy-to-grasp manner, enable a user to refer to at least two related pieces of information simultaneously and improve the efficiency in searching digital images by making a user use larger number of pieces of information.

Further, the object generation unit of the mobile terminal device concerning the present invention generates a two-dimensional object, the texture mapping unit generates image objects by mapping the first texture image onto a front surface of the two-dimensional object, and the second texture image onto a portion or a whole of peripheral part of the two-dimensional object, the block generation unit generates a block object by placing two-dimensional image objects in a diagonal direction in the three-dimensional space based on pieces of related information so that at least a part of image objects placed backward can be recognized, the image generation unit generates images of the block objects, and the display unit displays the images.

Therefore, as a user can confirm the parts of other image objects placed in the backward direction except a two-dimensional image object placed in the most front, it becomes possible to improve the userfriendliness in selecting images more.

Also, pieces of related information are given to the image objects, which enable the user to select images more easily.

Note that the present invention can be realized as an image display method where a unit installed in this mobile terminal device is regarded as a step and a program for causing a computer or the like to execute this image display method not only can be realized as a mobile terminal device as mentioned above. Further, the program can be distributed in a form of a recording medium such a CD-ROM or via a communication medium such as a communication network.

In this way, the user of the mobile terminal device concerning the present invention can display a plurality of images and the corresponding various kinds of pieces of information on the small display screen of the mobile terminal device by generating three-dimensional objects on the display screen using the three-dimensional computer graphics technique. In other words, as displaying photographs using the three-dimensional block objects enables a user to refer to image information and at least two related pieces of information simultaneously, it becomes possible to improve the efficiency in searching digital images by the user using the related pieces of information except these images. In addition, as colorful block objects are displayed on the display screen along with balloons and thus these images are displayed on the screen beautifully, the mobile terminal device becomes more enjoyable to a user.

In addition, the user of the mobile terminal device not only can select image ordering method of favorite image objects from a plurality of ordering methods but also can search the part of the image object placed toward the backward direction looking through image objects by making them as two-dimensional image objects, and thus it becomes possible to diversify a display method of the image object.

### FURTHER INFORMATION ABOUT TECHNICAL BACKGROUND TO THIS APPLICATION

The disclosure of Japanese Patent Application No. 2003-286005 filed on Aug. 4 th, 2003 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing an example of the functional structure of the mobile terminal device concerning a first embodiment;

FIG. 2 is a reference diagram of the screen display of the mobile terminal device concerning the first embodiment;

FIG. 3 is a reference diagram and a data table of the image object displayed in the mobile terminal device of the first embodiment;

FIG. 4 is a reference diagram and a data table of the block object displayed in the mobile terminal device of the first embodiment;

FIG. 5 is a reference diagram and a data table of the cursor object displayed in the mobile terminal device of the first embodiment;

FIG. 6 is a reference diagram and a data table of the frame cursor object displayed in the mobile terminal device of the first embodiment;

FIG. 7 is a reference diagram and a data table of the axis object displayed in the mobile terminal device of the first embodiment;

FIG. 8 is a reference diagram and a data table of the balloon object displayed in the mobile terminal device of the first embodiment;

FIG. 9 is an illustration showing the relation of the respective modes of the mobile terminal device concerning the first embodiment;

FIG. 10 is a flow chart showing the switching processing procedure of the respective modes of the mobile terminal device concerning the first embodiment;

FIG. 11 is a reference diagram of the thumbnail display mode displayed on the display screen of the mobile terminal device concerning the first embodiment;

FIG. 12 is a flow chart showing the display processing procedure in the case where the thumbnail display mode is selected in the display mode of the mobile terminal device concerning the first embodiment;

FIG. 13 is a reference diagram of the screen display of the block display mode in the mobile terminal device concerning the first embodiment;

FIG. 14 is a flow chart showing the display processing procedure in the case where the block display mode is selected in the display mode of the mobile terminal device concerning the first embodiment;

FIG. 15 is a reference diagram of the image display mode displayed on the screen of the mobile terminal device concerning the first embodiment;

FIG. 16 is a flow chart showing the processing procedure in the case where the image display mode is selected in the display mode of the mobile terminal device concerning the first embodiment;

FIG. 17 is a reference diagram of the display information selection mode displayed on the screen of the mobile terminal device concerning the first embodiment;

FIG. 18 is a flow chart showing the processing procedure in the case where the display information selection mode is selected in the display mode of the mobile terminal device concerning the first embodiment;

FIG. 19 is a reference diagram of the information input mode displayed on the display screen of the mobile terminal device concerning the first embodiment;

FIG. 20 is a flow chart showing the processing procedure in the case where the information input mode is selected in the display mode of the mobile terminal device concerning the first embodiment;

FIG. 21 is a reference diagram showing another display example of the image object of the mobile terminal device concerning the second embodiment;

FIG. 22 is a reference diagram showing another display example of the image object of the mobile terminal device concerning the second embodiment;

FIG. 23 is a reference diagram showing another display example of the image object of the mobile terminal device concerning the second embodiment; and

FIG. 24 is a reference diagram showing another display example of an image object generated by the mobile terminal device concerning the second embodiment.

### DESCRIPTION OF THE PREFERRED EMBODIMENT(S)

A mobile terminal device concerning the embodiment of the present invention will be explained below with reference to figures. Note that a mobile terminal device concerning the present invention is, for example, a mobile phone with a small display screen, a PDA, a car navigation device, a digital camera and the like.

(First Embodiment)

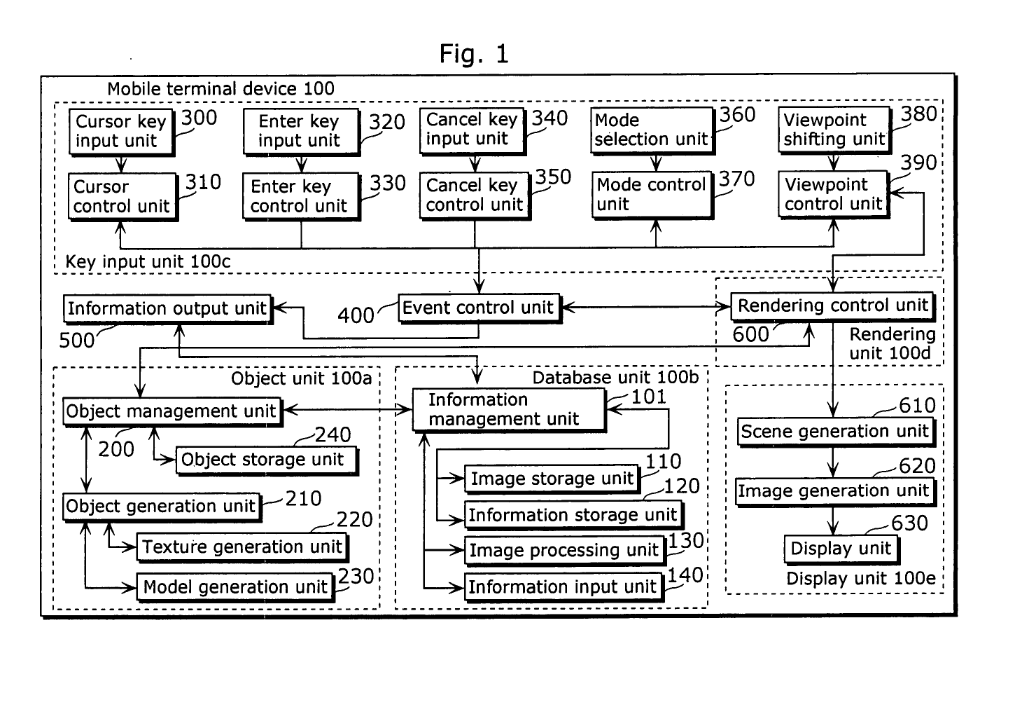

FIG. 1 is a block diagram showing an example of the functional structure of the mobile terminal device 100 concerning the first embodiment. The mobile terminal device 100 comprises an object unit 100a, a database unit 100b, a key input unit 100c, a rendering unit 100d and a display unit 100e. Details will be explained below.

Note that the mobile terminal device 100 concerning the first embodiment has a small display screen for displaying digital images, digital moving images and corresponding pieces of information, and it is characteristic in that it handles a large amount of images using three-dimensional CG technique instead of a thumbnail display method as block objects that are placed backward in the backward direction based on the pieces of related information corresponding to respective images.

The object unit 100a shown in FIG. 1 is a control unit operable to generate and store various objects composed of image objects, and comprises an object management unit 200, an object generation unit 210, a texture generation unit 220, a model generation unit 230 and an object storage unit 240. Also, this texture image generated by the mobile terminal device includes character information such as help information and the like.

The texture generation unit 220 generates texture images that are classified by color, shape, pattern and gradation associating with font image data that previously stores related information, such as “genre”, “priority”, “time of image shooting”, “reference frequency” and the like, corresponding to respective images to be passed from the data table of the object management unit 200 via the object generation unit 210.

The model generation unit 230 receives an instruction from the object generation unit 210 and generates object models to which texture images generated by the texture generation unit 220 are mapped onto. Also, block objects to be displayed on the display screen are generated by mapping the shot texture images onto the object model so as to generate image objects and placing the plurality of image objects in the three-dimensional space.

Note that there is a polygon model with three-dimensional coordinates as an object model. This polygon model has four peak coordinates in three-dimensional space and texture coordinates corresponding to respective one of peaks. Note that the polygon model can be not only a board-shaped polygon model with four peaks but also an object of a primitive or a polygon such as a ball or a cuboid.

The object generation unit 210 generates image objects that include related information on the side surface by mapping texture images generated by the texture generation unit 220 to the object models generated by the model generation unit 230. Block objects are generated by ordering these image objects like a cube in the backward direction.

The object storage unit 240 stores block objects generated by the object generation unit 210, image objects and the like according to an instruction from the object management unit 200.

The object management unit 200 instructs the object generation unit 210 to generate various kinds of objects necessary for generating scenes according to the instruction from the rendering control unit 600 and requests the information management unit 101 to make a data table for objects such as image objects, block objects and the like.

The database unit 100b shown in FIG. 1 stores various information concerning images displayed in the three-dimensional objects and comprises five processing units of an information management unit 101, an image storage unit 110, an information storage unit 120, an information processing unit 130 and an information input unit 140.

The information management unit 101 manages information stored in the image storage unit 110 and the information storage unit 120 based on image IDs and related information IDs. This information management unit 101 generates a data table where the pieces of information are stored in storage unit 110 and 120 according to an instruction from the object management unit 200 and passes the table to the object management unit 200.

The image storage unit 110 is a hard disc where the entities of the digital images displayed on the display screen are stored, and the image storage unit 110 can be a memory card such as an SD card in a mobile phone. This image storage unit 110 manages digital images using image IDs and sends digital images selected according to instructions from the information management unit 101. Note that it is possible to store digital moving images in the image storage unit 110 of the mobile terminal device 100 capable of shooting moving images.

The information storage unit 120 stores pieces of related information that is associated with images respectively. As these pieces of related information, for example, the pieces of information that are automatically mapped onto images at the time when each of these images is shot based on the EXif style format that is a standard for digital cameras. The above-mentioned pieces of information are the maker of the mobile terminal device, the model of the mobile terminal device, focus distance, image generation or shooting date and time, recording duration in the case where a moving image is displayed, image size, brightness and color. Also, other pieces of related information are the information extracted from images in the image processing unit 130, the information inputted by a user via the information input unit 140 such as image shooting locations, favorite degree, priority, genre and various kinds of pieces of information concerning images like reference frequency. Also, it is information on a location of photo shooting in the case of a GPS camera. Note that pieces of related information, which are characteristic for each digital image, are managed by IDs associated with image IDs respectively and stored in the information storage unit 120.

The image processing unit 130 extracts characteristic information from an image. Examples of characteristic information extracted from this image are the size of an area for people present in an image that can be calculated from the size of an area with skin color, the information whether a specific person such as “wife” or “child” is present or not, the information on how frequently a specific person appears, the color information indicating that the image is a green landscape. Also, based on the brightness information of the image, the pieces of information such as day or night, indoor or outdoor, and fine or rainy are extracted. After that, the image processing unit 130 records the characteristic information extracted from the image in the information storage unit 120 as the related information.

The information input unit 140 is a processing unit that inputs and updates pieces of related information concerning the images recorded in the information storage unit 120 based on direct inputs by a user. The information to be inputted is sent to the information storage unit 120 as pieces of related information in association with respective image IDs via the information management unit 101.

The key input unit 100c in the mobile terminal device 100 includes an input unit such as input bottoms or the like for user operation and a control unit.

The cursor key input unit 300 that is set on the mobile terminal device 100 includes four operation keys for shifting the cursor upward, downward, rightward and leftward respectively, and the keys are generally called as a cross key. The cursor key control unit 310 sends the information on the cursor location control on the display screen to the event control unit 400 according to inputs of the cursor key input unit 300 by the user of the mobile terminal device 100.

Here is an explanation on how the coordinates for placing the cursor object are calculated. In response to inputs by the user of the mobile terminal device 100, the cursor key input unit 300 sends, to the cursor control unit 310, key cords that are identifiers for the respective keys of up, down, right and left.

The cursor control unit 310 sends the information on which direction key cord is inputted to the event control unit 400. In the present invention, each key code input of up, down, right or left decides, for each display mode, the direction in the three-dimensional directions toward which the cursor shifts. Therefore, the event control unit 400 previously stores, as a data table, display modes set by the mode control unit 370 and associations between cursor directions of up, down, right and left and directions in the three-dimensional space. After that, the event control unit 400 sends the cursor shifting directions in the three-dimensional space to the rendering control unit 600 according to this data table. For example, in the case of a block display mode, the cursor directions of up, down, right and left indicate shifts to the directions of: the minus direction of axis Y; the plus direction of axis Y; the minus direction of axis X; and the plus direction of axis X in the three-dimensional space respectively.

Here is an explanation on the placing method of the cursor object. The rendering control unit 600 judges whether which object is selected based on the object placing information and the cursor shifting direction and sends the object ID selected by the cursor to the scene generation unit 610. The scene generation unit 610 calculates the cursor coordinates based on the coordinates of the selected object and places the cursor object.

The enter key input unit 320 is an operation bottom used when the user of the mobile terminal device 100 selects a piece of specific information from plural pieces of displayed information and when the user selects a favorite image object from plural image objects.

The enter key control unit 330 sends the information on the status of the enter key to the event control unit 400 based on the enter key inputted by the enter key input unit 320. For example, in response to the selection of a specific image through the enter key input unit 320, the event control unit 400 sends the selected image to the information output unit 500.

The cancel key input unit 340 is an operation bottom for canceling the once-selected information according to user inputs The cancel key control unit 350 sends the information on the status of the cancel key to the event control unit 400 based on the key code of the cancel key inputted by the cancel key input unit 340. The event control unit 400 displays the contents before the cancellation based on the information from each control unit. For example, selection history of the display mode is stored in the mode control unit 370 and selection history of the viewpoint is stored in the viewpoint control unit 390. Therefore, with the cancel key input unit 340, it becomes possible to return to the previously selected display mode or viewpoint.

The mode selection unit 360 is an input unit enabling a user of the mobile terminal device 100 to select a display mode concerning the present invention. The mode control unit 370 sends notifies the event control unit 400 of the display mode selected in the mode selection unit 360.

The viewpoint shifting unit 380 is a group of operation bottoms comprising the following nine key input units: in order to enable a user to change viewpoints to an image on the display screen, (i) a zoom key (ii) a scroll key; and in order to rotate the image, (iii) a zoom-up key, (iv) a zoom-down key, (v) scroll keys of up and down, (vi) scroll keys of right and left, (vii) axis X rotation key, (viii) an axis Y rotation key, and (ix) an axis Z rotation key.

The viewpoint control unit 390 receives, from the viewpoint shifting unit 380, key codes that are identifiers corresponding to these keys respectively, calculates viewpoint coordinates and sends these viewpoint coordinates to the scene generation unit 610 via the rendering control unit 600. Also, it notifies the event control unit 400 of the viewpoint shifting.

The rendering unit 100d is a processing unit for rendering based on the position information of objects sent by the object management unit 200.

The rendering control unit 600 receives instructions on display modes from the event control unit 400. After that, it makes an order for generating objects necessary for the display mode selected by the object management unit 200 and receives objects generated by the object management unit 200. Also, on receiving an order for viewpoint shifting such as zoom-up or zoom-down from the viewpoint control unit 370, it makes an order for generating images for which viewpoint is shifted by the scene generation unit 610.

The display unit 100e is a processing unit for generating and displaying images to be displayed on the display screen of the mobile terminal device 100 and comprises a scene generation unit 610, an image generation unit 620 and a display unit 630.

In response to the rendering control unit 600, the scene generation unit 610 places the generated image objects according to the position information stored in the position information storage unit 640 so as to generate block objects and places other objects based on the display mode.

The image generation unit 620 calculates what the three-dimensional images look like from the viewpoint coordinates selected by the user via the viewpoint shifting unit 360 when the scene generation unit 610 finishes placing all the objects and outputs the result to the display unit 630 as image information. For example, in the case where a thumbnail display mode is selected, the rendering control unit 600 sets the viewpoint at the initially set positions corresponding to respective display modes.

The display unit 630 performs processing for displaying images generated by the image generation unit 620 on the display screen of the mobile terminal device 100.

The event control unit 400 receives instructions from respective control units 310 and the like and gives them instructions so as to cause the mobile terminal device 100 to execute operations such as display mode shifting required by the user.

The information output unit 500 is a processing unit for outputting information to an external device, and outputs images and the pieces of related information to a mail generation device and other devices to be set in the mobile terminal device 100 according to the instruction such as sending mail with an image from the event control unit 400. Examples of external devices are a mail generation device for sending mail to mail addresses included in the “personal information”, a telephone speech device for calling people included in the “personal information”, an editing device for edit addresses and other pieces of information on people included in the “personal information”, a printing device for print images, an external storage device and the like.

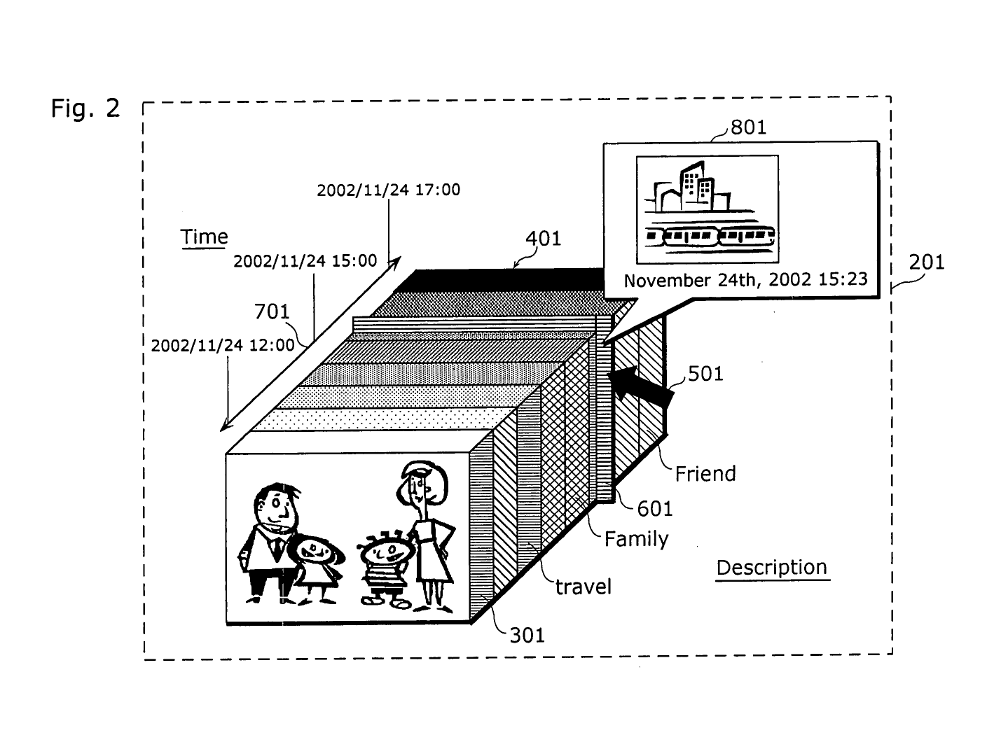

FIG. 2 is a reference diagram of screen display of the mobile terminal device 100 concerning the first embodiment. On the display screen 201 of the mobile terminal device concerning the present invention, images are displayed in a thumbnail display mode where balloons for images are displayed at the positions indicated by the cursor.

In this thumbnail display mode, an image object 301, a block object 401, a cursor object 501, a frame cursor object 601, an axis object 701 and a balloon object 801 are displayed on the display screen based on the position information. Therefore, the user can simultaneously refer to pieces of related information except pieces of image information by displaying block objects on the display screen 201.

Next, respective objects generated by the object generation unit 210 in the mobile terminal device 100 concerning the first embodiment will be explained. Objects to be used in this invention are the following six kinds: an image object 301, a block object 401, a cursor object 501, a frame cursor object 601, an axis object 701 and a balloon object 801. Note that different object is used in each display mode.

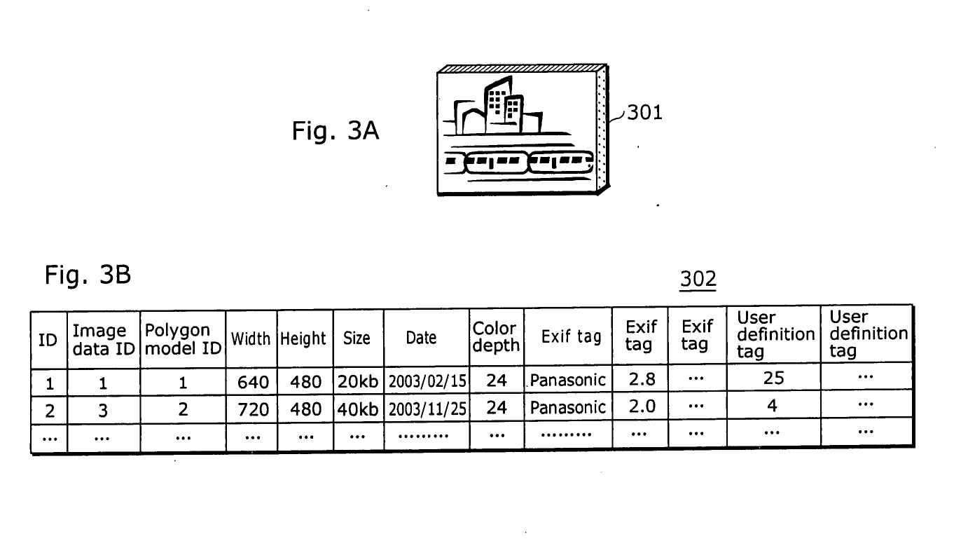

FIG. 3 is a reference diagram and a data table 302 of the image object 301 displayed on the screen display of the mobile terminal device 100 in the first embodiment.

The image object 301 shown in FIG. 3A is an object obtained by visualizing images and the corresponding pieces of related information and comprises two-dimensional texture images stored in the image storage unit 110 and a polygon model with three-dimensional coordinates generated by the model generation unit 230 for placing these texture images in the three-dimensional space and performing rendering on them.

In the data table 302 shown in FIG. 3B, the information associated with the image object 301 is stored. To be more specific, they are the image data ID stored in the image storage unit 110, the polygon model ID generated by the model generation unit 230, the width and height of an image, the image size, the date when the image is shot, the color depth, the Exif tag, the user definition tag and the like. Note that the Exif tag is a standard for digital cameras. Also, it indicates pieces of information automatically given to the images when the irrespective images are shot, to be more specific, these pieces of information are the maker and model of the mobile terminal device, its focus distance and the like. Also, the user definition tag indicates the information inputted via the information input unit 140 and the information extracted in the image processing unit 130 and indicates the location information, favorite degree and the like.

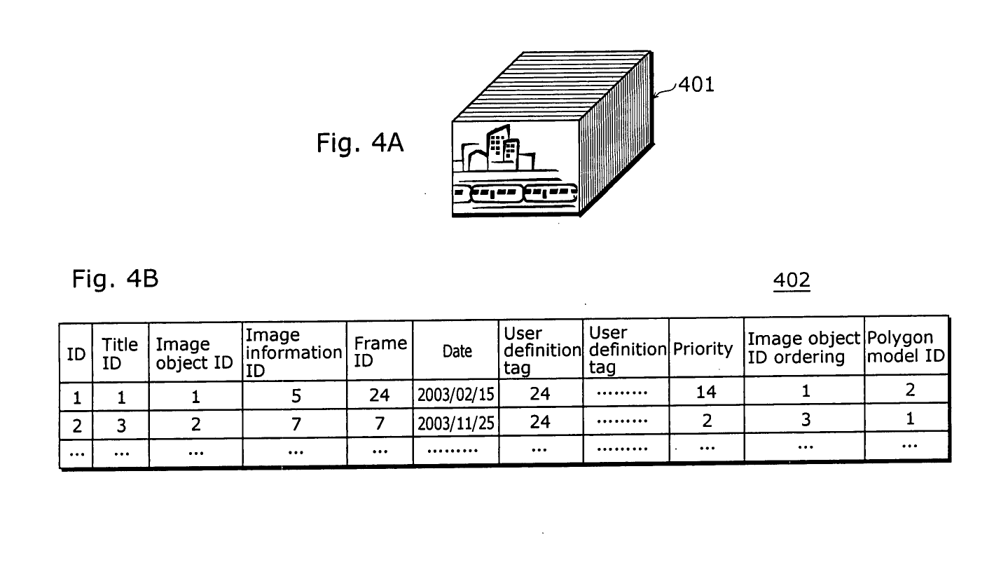

FIG. 4 is a reference diagram and a data table 402 of the block object displayed in the mobile terminal device 100 in the first embodiment.

The block object 401 shown in FIG. 4A is a three-dimensional object made by placing plural image objects like a rectangular solid. Pieces of related information for the respective image objects 301 of the block objects 401 are visualized so as to be mapped onto the sides of the respective image objects as textures. Also, image objects 301 of the block object 401 are related to each other like an album.

Pieces of information stored in the data table 402 shown in FIG. 4B are: title IDs such as an album name of the block object 401, respective image object IDs, information IDs given to respective surfaces, frame IDs indicating the number of images and image objects, the dates when the respective image objects are shot, user definition tags of pieces of information such as travel destinations, priorities of the respective image objects, the ID ordering of these image objects, polygon model IDs and the like.

Note that a texture image may be mapped onto the image displayed on the front surface of the block object 401, the texture image being, for example, a typical image in images such as “a people photograph the travel to Kyoto” in an album including images shot during the travel to Kyoto, an image with the highest value or an image with the lowest value at the time when sorting images based on a kind of information included in the block object 401, or an image selected by a user.

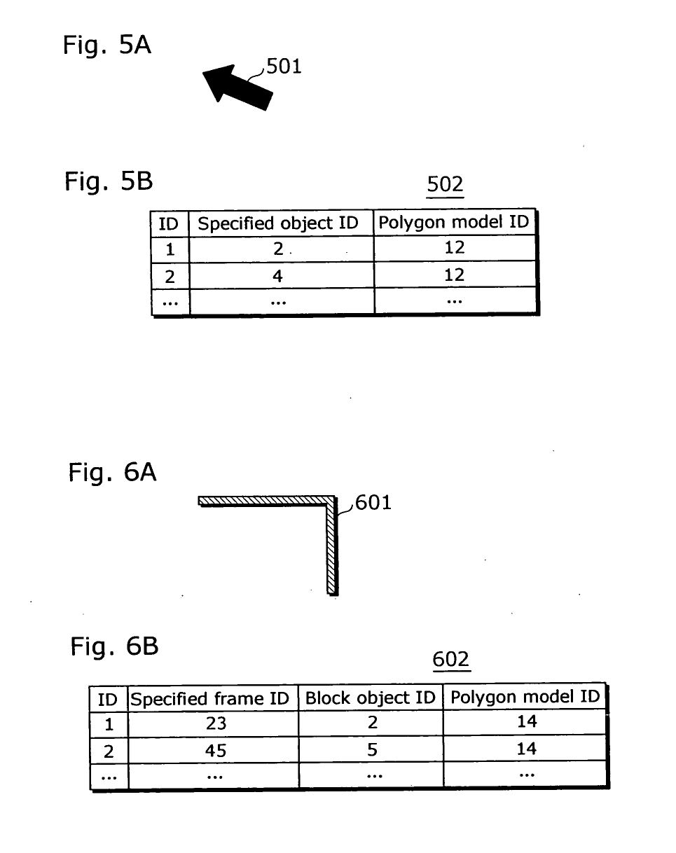

FIG. 5 is a reference diagram and a data table 502 of the cursor object 501 to be displayed on the display screen of the mobile terminal device 100 in the first embodiment.

In FIG. 5A, the cursor object 501 displayed on the display screen is an arrow. For example, the arrow is used when the user of the mobile terminal device 100 selects an image object 301 from block objects 401 in a thumbnail display mode, and it is operated via the cursor key input unit 300.

In the data table 502 shown in FIG. 5B, IDs, IDs of the specified objects and polygon model IDs are stored.

FIG. 6 is a reference diagram and a data table 602 of the frame cursor object 601 displayed on the display screen of the mobile terminal device 100 in the first embodiment.

The frame cursor object 601 shown in FIG. 6A is displayed so as to show, in an outstanding way, a position of an image object 301 shown by the cursor object 501 in the block object 401 in a mode such as the thumbnail display mode.

In the data table 602 shown in FIG. 6B, IDs, frame IDs making an instruction for selecting the shape of a frame, block object IDs, polygon model IDs and the like are stored.

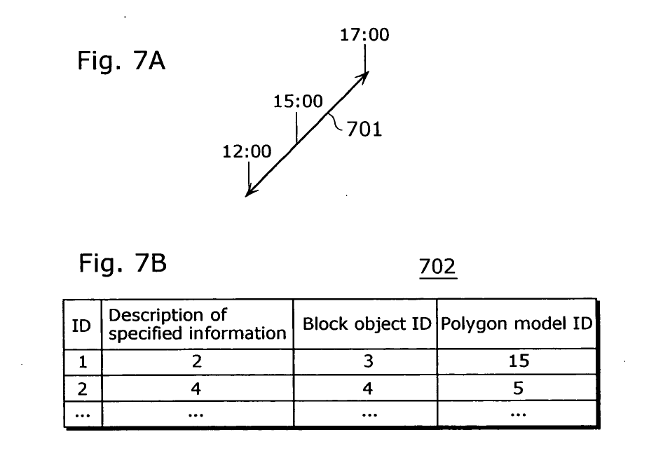

FIG. 7 is a reference diagram and a data table 702 of the axis object 701 displayed on the display screen of the mobile terminal device 100 in the first embodiment.

The axis object 701 shown in FIG. 7A is for displaying time information and the like of the block object 401 in the thumbnail display mode. Also, in the data table 702 shown in FIG. 7B, IDs, the contents of the information specified by the axis object 701, block object IDs, polygon model IDs and the like.

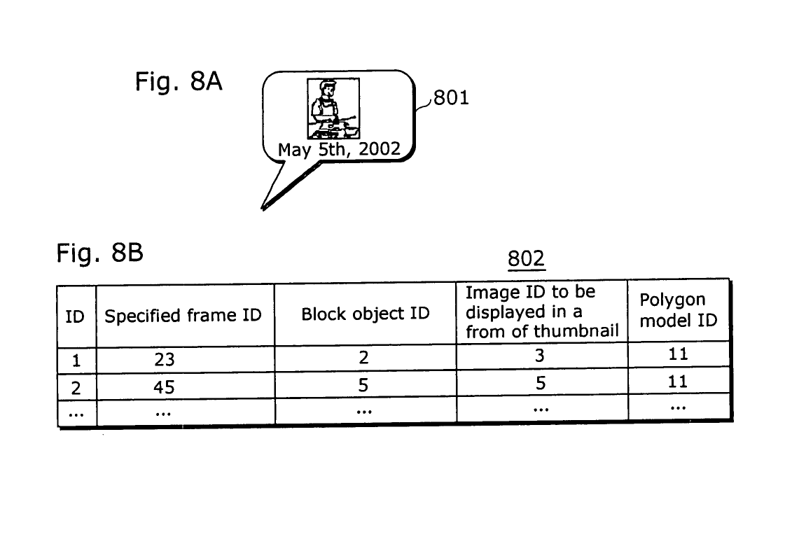

FIG. 8 is a reference diagram and a data table 802 of the balloon object 801 displayed on the display screen of the mobile terminal device 100 in the first embodiment.

The balloon object 801 shown in FIG. 8A is used for displaying the thumbnail of the image object 301 with a frame placed at the position specified by the cursor object 501, and it can also display related information of the image object 301 such as the date when the image was shot along with the thumbnail image.

In the data table 802 shown in FIG. 8B, frame IDs making an instruction for selecting the shape of a frame, block object IDs, IDs of images to be displayed in a form of thumbnail, polygon model IDs and the like are stored.

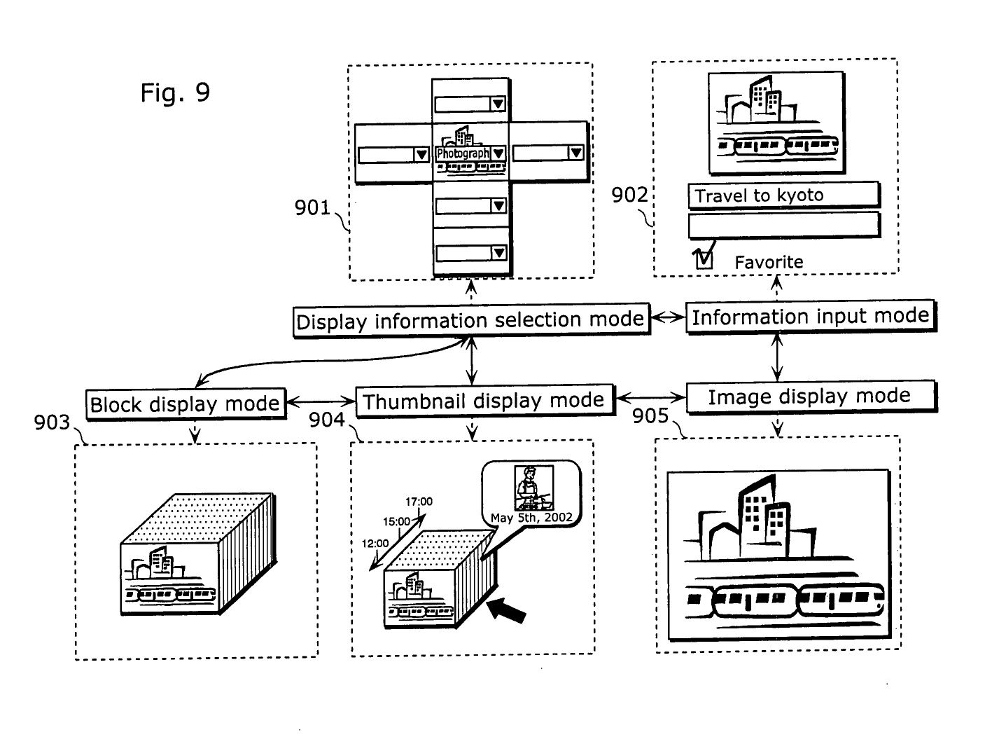

FIG. 9 is an illustration showing the relationship among respective display modes of the mobile terminal device 100 concerning the first embodiment. As types of object display modes for the mobile terminal device 100 are a display information selection mode 901, an information input mode 902, a block display mode 903, a thumbnail display mode 904 and an image display mode 905.

The user selects a display mode in the mode selection unit 360 and shifts to another display mode by performing key inputs in respective display modes. For example, as soon as the user selects a single block object 401 from plural block objects 401 in the block display mode 903 using the enter key input unit 320, the present mode automatically shifts to the thumbnail display mode 904. Also, as soon as the user selects an image object 301 in the thumbnail display mode 904 using the enter key input unit 320, the present mode shifts to the image display mode 905 for displaying the image.

It is possible to shift to the information input mode 902 using a mode selection unit 360 in, for example, the image display mode 905. Also, using the cancel key input unit 340 makes it possible to return to the previous mode because the selection history of modes is stored in the mode control unit 370.

Also, it is possible to shift to the block display mode 903 and the thumbnail display mode 904 via the mode selection unit 360 by which pieces of information displayed on respective surfaces are decided in the display information selection mode 901. Also, selecting digital images by the enter key input unit 320 in the display information selection mode 901 makes it possible to shift to the information input mode 902.

As explained up to this point, in the mobile terminal device 100 concerning the first embodiment, the user can shift to another display mode using the mode selection unit 360, and it is possible to realize a mobile terminal device 100 with an improved user operability.

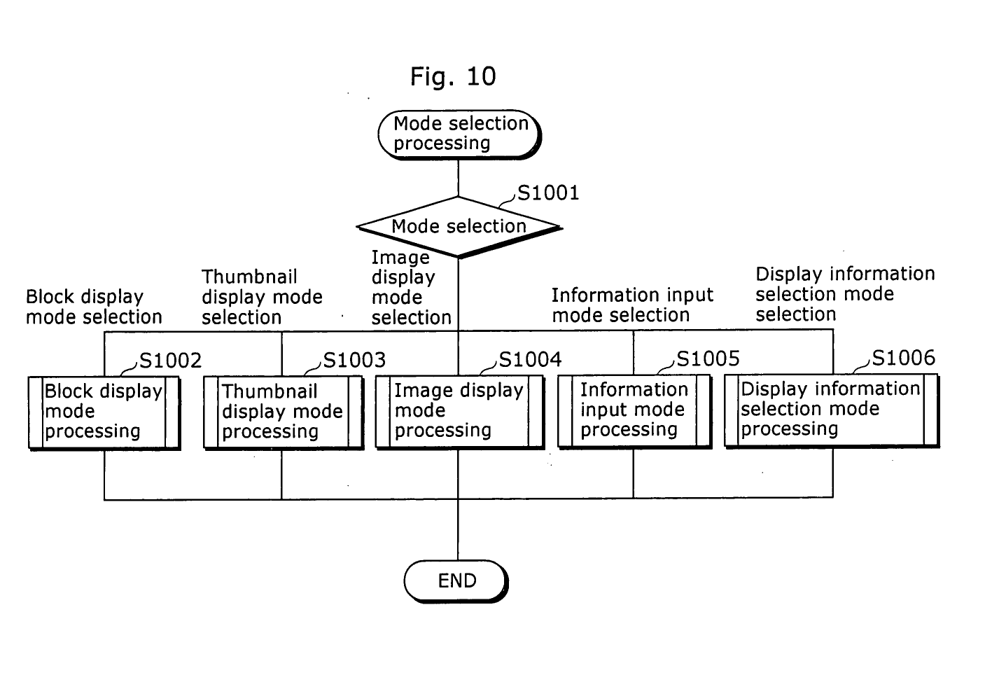

FIG. 10 is a flow chart showing the processing procedure for shifting to respective modes in the mobile terminal device 100 concerning the first embodiment.

The user of the mobile terminal device 100 selects a single display mode (S1001) based on a key input in the mode selection unit 360 and the information indicated by a mode key corresponding to the display mode.

The event control unit 400 performs block display mode processing (S1002) in the case where the user of the mobile terminal device 100 selects the block display mode, thumbnail display mode processing (S1003) in the case where the user selects the thumbnail display mode, image display mode processing (S1004) in the case where the user selects the image display mode, information input mode processing (S1005) in the case where the user selects the information input mode, and display information selection mode processing (S1006) in the case where the user selects the display information selection mode.

Five display modes used for the display screen of the mobile terminal device 100 concerning the embodiment will be explained below in sequence, these modes are a block display mode, a thumbnail display mode, an image display mode, an information input mode and a display information selection mode. Note that these display modes are examples, and that display modes used for the mobile terminal device 100 concerning the present invention are not limited to these display modes.

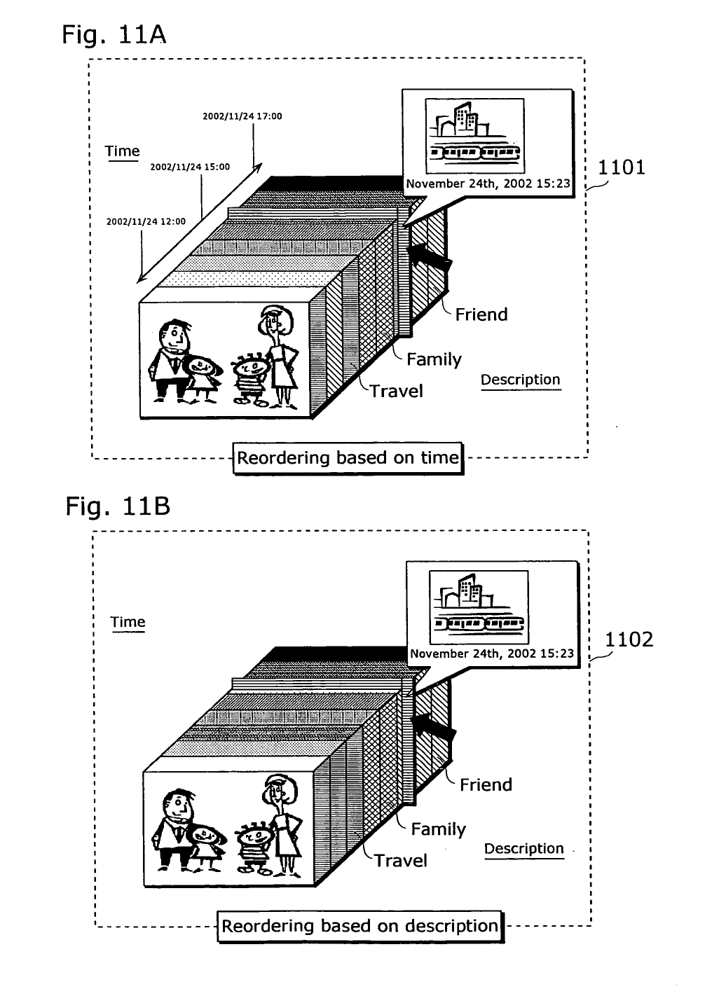

FIG. 11 is a reference diagram of the thumbnail display mode used for the display screen of the mobile terminal device 100 concerning the first embodiment.

In the thumbnail display mode, it is possible to search and look through image objects of the block objects displayed on the display screen along with plural pieces of information so as to classify favorite images into a single folder like an album, delete unnecessary images or edit a lot of images by referring to the three-dimensional block objects.

Also, FIGS. 11A and 11B are reference diagrams in the case where image reordering is performed based on the pieces of related information of the respective image objects. Also, it is possible to reorder these image objects in time sequence as shown in FIG. 11A or reorder them based on categories as shown in FIG. 11B. Also, it is possible to reorder them based on priorities on condition that pieces of related information are added to the corresponding image objects as a texture image.

In this way, in the thumbnail display mode, it is possible to search images using pieces of related information and display these image objects as a block object where these image objects are reordered according to these pieces of related information. Note that the user reorders these image objects via the key input unit 100c for reordering so as to display requested images from front to back based on pieces of favorite information, and thus that the user can select images more easily.

The operation in the thumbnail display mode will be explained below.

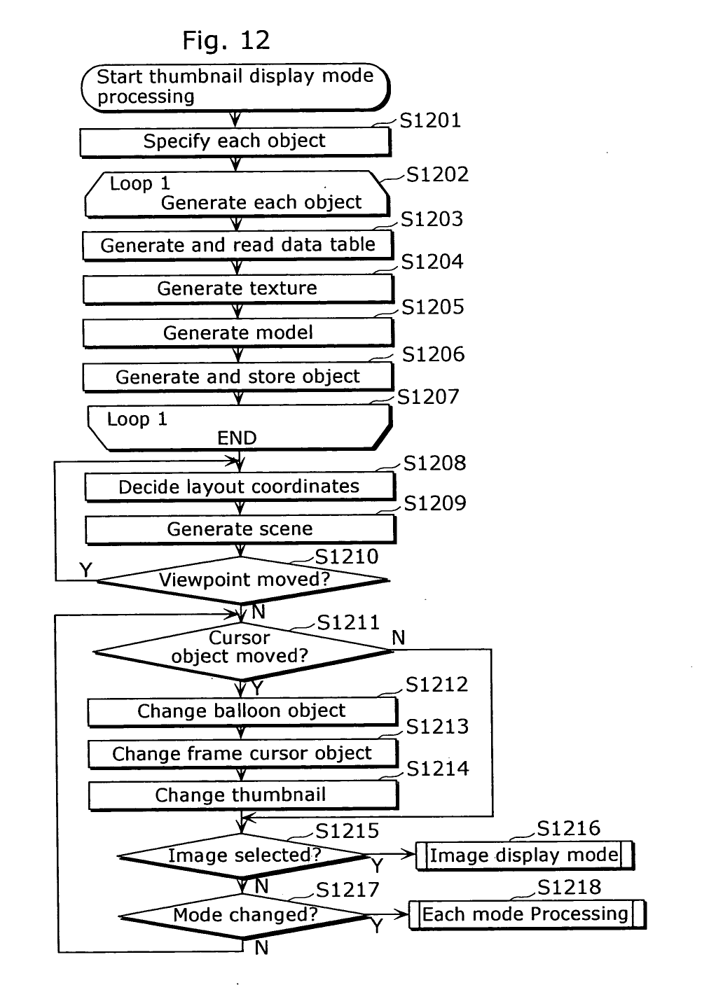

FIG. 12 is a flow chart showing the display processing procedure of the mobile terminal device 100 concerning the first embodiment in the case where the thumbnail display mode is selected.

First, when the thumbnail display mode is selected in the mode selection unit 360, the event control unit 400 sends, to the rendering control unit 600 a specification of the objects necessary in the thumbnail display mode. In the thumbnail display mode, objects to be specified are a block object, a cursor object, a frame cursor object, a balloon object, an image object and an axis object (S1201).

Next, the event control unit 400 orders the rendering control unit 600 to render the specified objects (S1202). After that, the rendering control unit 600 requests the object management unit 200 to generate these objects, and the object management unit 200 requests the information management unit 101 to obtain images and the pieces of corresponding related information. In the case where there is any object that is not stored in the object storage unit 240, the object management unit 200 requests the information management unit 101 to obtain these digital images and the corresponding pieces of related information that are added to these images.

The information management unit 101 generates an image object data table where each image to which an image object ID is given is associated with the pieces of related information and send the table to the object management unit 200 (S1203). Note that the information management unit 101 generates a data table by obtaining pieces of related information from the information storage unit 110 using the related information IDs stored in the information management unit 101 and pieces of corresponding information of addresses stored in the information storage unit 110. Note that data tables for respective objects are shown in the above-mentioned FIG. 3 to FIG. 8.

Also, the information management unit 101 generates a block object data table indicating image object IDs included in the block information and the block object and sends it to the object management unit 200 (S1203). Next, the information management 101 generates a data table including a cursor object where the default value stored in the information storage unit 120, a frame cursor object, a balloon object and an axis object (S1203) and send them to the object management unit 200.

After that, the object management unit 200 request the object generation unit 210 to generate the image objects included in the block object data table. The object generation unit 210 obtains the necessary pieces of information on the respective image objects from the information management unit 101 referring to the image object IDs included in the block object data table.

Also, the object generation unit 210 passes the image object data table obtained from the object management unit 200 to the texture generation unit 220 and the model generation unit 230.

The texture generation unit 220 generates the image data including texture images according to the respective pieces of related information of the image objects or two-dimensional texture images in combination with the font image data (S1204).

The model generation unit 230 generates a rectangular polygon model according to the descriptions in the image object data table (S1205). Note that the polygon model has eight peak coordinates in three-dimensional space and texture coordinates respectively corresponding to those eight peaks.

The object generation unit 210 generates image objects from the pieces of information obtained by using the texture images generated by the texture generation unit 220 and the polygon model generated by the corresponding model generation unit 230 (S1206). The generated image objects are stored in the object storage unit 240 (S1206) by the object management unit 200. Likewise, in the object generation unit 210, other necessary objects are generated in the thumbnail display mode.

When all the objects are generated and stored, the object management unit 200 notifies the rendering control unit 600 that all the objects needed for rendering have already generated and finishes the loop for generating objects (S1207).

After that, the rendering control unit 600 sends respective objects to the scene generation unit 610 along with pieces of viewpoint information obtained by the viewpoint control unit 390.

The scene generation unit 610 decides position coordinates of the respective objects (S1208) and generates a scene displayed on the display screen by placing a block object, a cursor object, a frame cursor object, a balloon object and an axis object in the three-dimensional space based on the decided position coordinates (S1209). Note that the position information is described in a way that three-dimensional coordinate ordering is realized as shown in FIG. 11 in the thumbnail display mode.

When all the objects are placed by the scene generation unit 610, the image generation unit 620 calculates what the three-dimensional space look like from each of the viewpoint coordinates obtained from the viewpoint control unit 390 and outputs the results to the display unit 630 as image information. In the case where viewpoint has changed in this viewpoint shifting unit 380 (Y in S1210), the image generation unit 620 decides position coordinates again based on the new viewpoint.

Next, in the case where viewpoint has not changed in the viewpoint shifting unit 380 (N in S1210), whether the cursor object has shifted via the cursor key input unit 300 or not is judged (S1211). Also, for example, up and down of the cursor control unit 310 mean shifting to the minus direction and the plus direction of axis Z respectively in the thumbnail display mode. When pressing the up or down key of the cursor control unit 310, “indicated object ID” that is the information indicated by the cursor object changes accordingly. After that, the cursor object is placed at the same position of corrdinate Z as the coordinate Z of the indicated image object.

Likewise, in the case where the cursor object has shifted (Y in S1211), “indicated object ID” of the frame cursor object changes to the one placed upward or downward and the frame cursor object is placed accordingly (S1212).

Likewise, the balloon object is placed (S1213), the image object indicated by the cursor is displayed as a thumbnail image object in a balloon (S1214). Therefore, the user can easily look through the images, which are of the block object, in balloon objects by shifting the cursor upward or downward using the cursor key. In the case where the cursor object has not shifted (N in S1211), processing after image selection processing (S1215) is performed.

Next, the user selects an image to be displayed on the display screen from the images displayed in balloon objects (S1215). In the case where an image is selected (Y in S1215), the thumbnail mode is changed to the image display mode (S1216).

Next, whether the user of the mobile terminal device 100 has changed modes using the mode selection unit 360 (S1217), the selected mode display processing is performed in the case where the mode is changed (S1218), and next, whether the cursor object has shifted by the cursor key input unit 300 is confirmed (S1211) in the case where the mode is not changed. In this way, image objects are displayed in the thumbnail mode as shown in FIG. 11.

Up to this point, in the thumbnail display mode of the mobile terminal device 100 concerning the first embodiment, the three-dimensional block object comprising images to which pieces of related information are added are displayed. Therefore, using larger number of pieces of information makes it possible to improve the efficiency in searching digital images by a user.

Also, as a colorful block object including images is displayed, it becomes possible to make user operation more enjoyable because objects can be displayed on the display screen of the mobile terminal device 100 more beautifully.

A block display mode will be explained below.

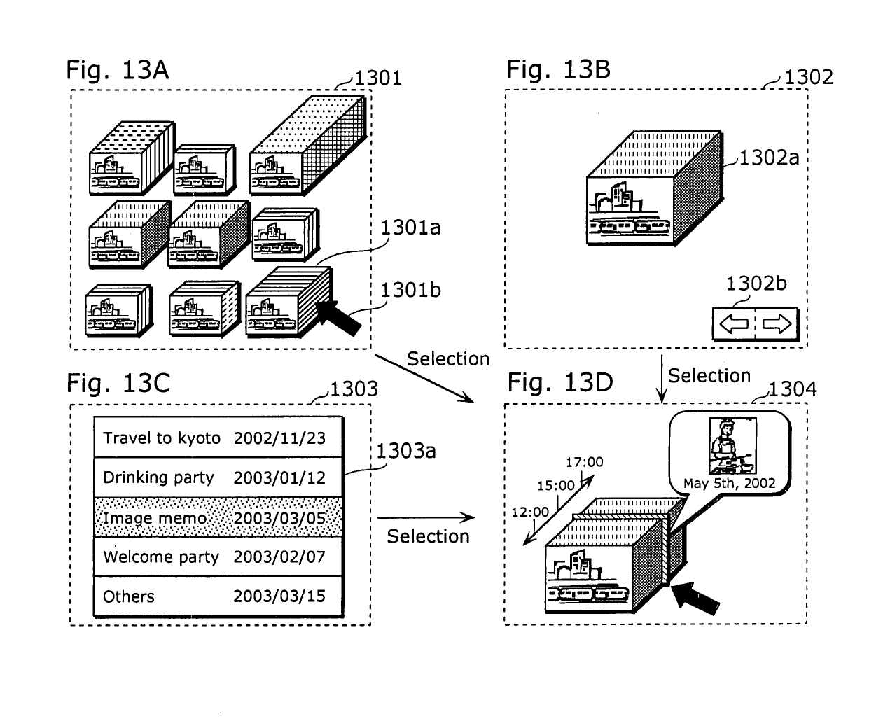

FIG. 13 is a reference diagram for the screen display of the mobile terminal device concerning the embodiment in the block display mode. The feature of the block display mode is to display a group of image objects classified into the group based on pieces of related information as a block object like an album.

FIG. 13A is a display screen 1301 where plural block objects 1301a are placed in the three-dimensional space. Each block object is displayed like an album including a group of digital images related to each other, for example, images concerning “athletics meets in September” or images concerning “travel to Kyoto in November”. The user can select a block object to be edited from these block objects using the cursor object 1301b through the cursor key input unit 300 and move the block object to the display screen 1304 of the thumbnail display mode shown in FIG. 13D.

FIG. 13B displays the block object 1302a on the display screen 1302 in sequence and change the block object 1302a displayed according to the arrow 1302b displayed through the cursor key input unit 300 to another block object 1302a. After selecting the block object 1302a through the decision key input unit 320, the user of the mobile terminal device 100 can shift to the display screen 1304 in the thumbnail display mode shown in FIG. 13D.

Note that no block object is displayed on the display screen 1303 shown in FIG. 13C, but a list 1303a where titles of a group of albums stored in the image storage unit 110 are listed in the order of priorities or time sequence. These titles are, for example, “a travel to Kyoto”, “drinking party” and the like. When the user of the mobile terminal device 100 selects an item on the list via the enter key input unit 320, the user can shift to the display screen 1304 for the thumbnail display mode shown in FIG. 13D.

Operations in the block display mode are explained below.

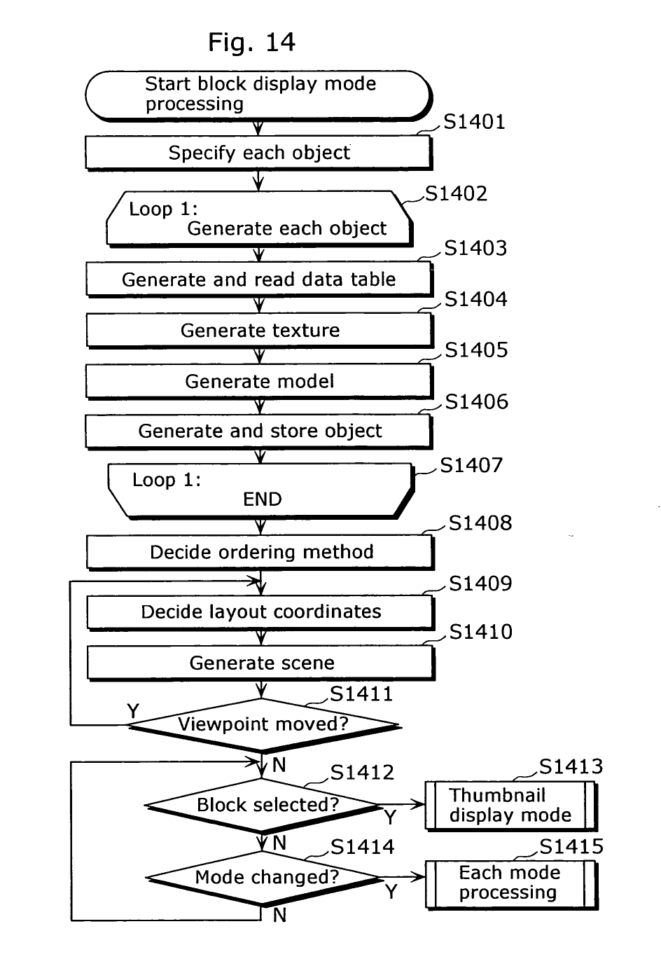

FIG. 14 is a flow chart indicating display processing procedure of the mobile terminal device 100 concerning the first embodiment in the case where the block display mode is selected.

First, when the block display mode is selected by the mode selection unit 360, the event control unit 400 sends a specification on objects necessary in the block display mode to the rendering control unit 600. Objects to be specified in the block display mode are image objects, block objects, and a cursor object (S1401).

Next, the event control unit 400 orders the rendering control unit 600 to render the specified objects (S1402). After that, the rendering control unit 600 requests the object management unit 200 to generate these objects, and the object management unit 200 request the information management unit 101 to obtain the images and the pieces of related information for each image.

The information management unit 101 generates an image object data table where each image to which an image object ID is given is associated with the pieces of related information and send the table to the object management unit 200 (S1403). Note that the information management unit 101 generates a block object data table indicating block information and IDs of the image objects of the block object and sends them to the object management unit 200 (S1403). Likewise, the information management unit 101 generates a data table of the cursor object where the default value stored in the information storage unit 120 is set (S1403) and sends it to the object management unit 200.

After that, the object management unit 200 request the object generation unit 210 to generate image objects included in the block object data table. The object generation unit 210 obtains, from the information management unit 101, the pieces of information on the necessary image objects based on the IDs of the image objects of the block object data table. Also, the object generation unit 210 passes the image object data table obtained from the object management unit 200 to the texture generation unit 220 and the model generation unit 230.

The texture generation unit 220 generates two-dimensional texture images according to the pieces of related information of the image objects (S1404).

The model generation unit 230 generates a rectangular polygon model according to the descriptions in the image object data table (S1405). The object generation unit 210 generates a block object (S1406) based on the obtained pieces of information using the texture images generated by the texture generation unit 220 and the polygon model generated by the corresponding model generation unit 230. The generated block object is stored in the object storage unit 240 by the object management unit 200 (S1406). When all the objects are generated and stored, the object management unit 200 notifies the rendering control unit 600 that all the objects have generated and finishes the loop for generating objects (S1407).

After that, the rendering control unit 600 decides the method for placing respective block objects (S1408) in the block display mode according to the inputs through the mode selection unit 360 or the enter key input unit 320. Also, when the object management unit 200 notifies that all the image objects necessary for rendering have generated, the rendering control unit 600 sends block objects along with the viewpoint information obtained from the viewpoint control unit 390 to the scene generation unit 610.

In the case where plural block objects are placed in the three-dimensional space in the block display mode, viewpoint is set in a way that the values of the maximum horizontal and vertical sizes of the block object can be fully displayed at once are previously stored in the rendering control unit 600, all the block objects are placed like a matrix, and the maximum number of block objects that can be displayed at once on the display screen. Changing viewpoints through the viewpoint shifting unit 380 enables the user to look through all the block objects.

Also, in the case of displaying block objects one by one in the block display mode, they can be ordered based on the order of: block IDs; priorities defined by the user; or pieces of related information for the respective block objects, for example, dates and changes block objects to be displayed by using the right and left cursor keys in the cursor key input unit 300. It is also possible to employ an additional function enabling to display them in a unit of five by using the upward cursor key or the downward cursor key.

It is conceivable that albums stored in the image storage unit 110 in the block display mode are displayed in a form of a list. In this case, titles of the respective block objects are displayed in a form of a list based on the order of: object image IDs; priorities defined by the user; or pieces of related information for the respective block objects. It is also possible to change block objects selected by using the upward cursor key or the downward cursor key, and employ an additional function enabling to display them in a different way by using the rightward cursor key or the leftward cursor key.

Up, down, right and left of the cursor control unit 310, in the block display mode, mean the plus direction of axis Y, the minus direction of axis Y, the minus direction of axis X and the plus direction of axis X in the three-dimensional space shown in FIG. 13 respectively. In response that the upward cursor key or the downward cursor key is pressed, “indicated object ID” that is a piece of information indicated by the cursor object shifts upward or downward accordingly. The cursor object is placed on the object should be indicated.

The scene generation unit 610 decides the position coordinates of the respective object using the ordering method and the viewpoint information for the block objects (S1409). Note that position coordinates are described so that they become a three-dimensional coordinate ordering in the block display mode. With these decided position coordinates, a scene where the block objects and the cursor object are placed in the three-dimensional space so as to be displayed on the display screen (S1410). The image generation unit 620 calculates what the three-dimensional images look like from the viewpoint coordinates selected by the user via the viewpoint shifting unit 390 when the scene generation unit 610 finishes placing all the objects and outputs the result to the display unit 630 as image information. Up to this point, the display screen in the block display mode as shown in FIG. 13 is displayed.

In the case where the viewpoint has changed as a result of the confirmation of whether the viewpoint has changed by the viewpoint shifting unit 380 or not (S1411), the image generation unit 620 performs processing after the decision of position coordinates based on the new viewpoints (S1409).

Next, in the case where the viewpoint has not changed by the viewpoint shifting unit 380 (N in S1411), the user selects a block object to be displayed on the display screen of edited (S1412) from block objects displayed in the block display mode via the enter key input unit 320. In the case where a block is selected (Y in S1412), the block display mode is changed to the thumbnail display mode so as to display the selected block object (S1413).

As a result of the confirmation of whether the mode has been changed or not by the mode selection unit 360 (S1414), in the case where it has been changed (Y in S1414), the selected mode display processing is performed (S1415), while in the case where it has not been changed (N in S1414), the processing after the block selection (S1412) will be repeated.

As explained above, in the block display mode of the mobile terminal device 100 concerning the first embodiment, a group of digital images concerning a travel or an event can be displayed on the display screen as a single block object like an album, and the user can change the mode to the thumbnail display mode where the respective digital images can be edited by selecting a block object via the enter key input unit 320.

Therefore, the user can look through a group of albums recorded in the mobile terminal device 100 as block objects, which improves the operability in image searching.

As those block objects are displayed in the backward direction in proportion to the data amount of the stored digital images, the user can visually confirm the data amount of the shot digital images.

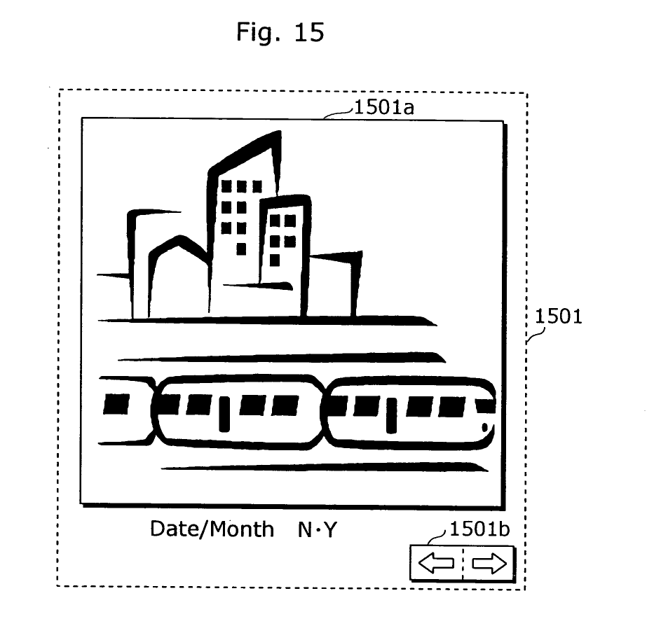

FIG. 15 is a reference diagram in the image display mode for the display screen of the mobile terminal device 100 concerning the first embodiment. In the image display mode, the image 1501a selected in the thumbnail display mode or the like will be displayed on the screen display 1501. Note that it is possible to display pieces of related information linked to the image 1501a displayed on the display screen 1501, and also change images using a display arrow 1501b.

Operations in the display mode will be explained below.

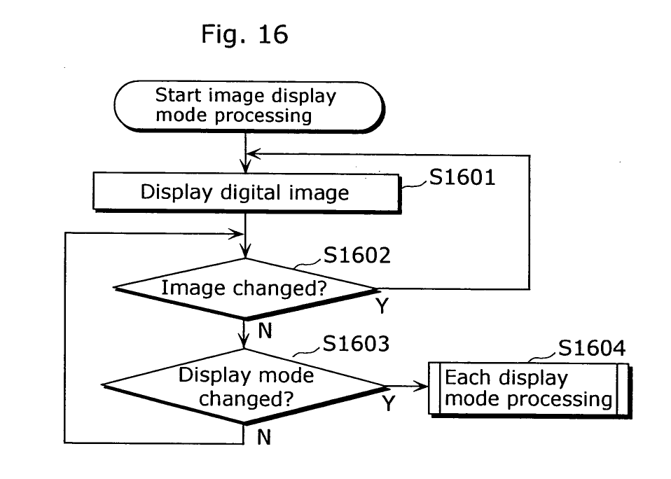

FIG. 16 is a flow chart showing the processing procedure for the mobile terminal device 100 concerning the first embodiment in the case where the image display mode is selected.

When the image display mode is selected in the mode selection unit 360, the event control unit 400 sends a specification of the digital images necessary in the image display mode to the rendering control unit 600. The rendering control unit 600 obtains digital images specified based on the identification number by the image storage unit 110. The image generation unit 620 sends the obtained digital images to the display unit 630 as they are and displays digital images by the display unit 630 (S1601).

In the image display mode, the up and the down in the cursor key input unit 300 mean change of image objects, in other words, “indicated object ID” that is a piece of information indicated by the cursor object is changed to another one placed upward or downward by pressing the corresponding cursor key of the upward cursor key or the downward cursor key in the cursor key input unit 300. When the indicated image object has changed, the rendering control unit 600 obtains digital images specified by the image storage unit 110 and changes distal images to be displayed (Y in S1602).

Next, in the case where images are not changed (N in S1602) and the user of the mobile terminal device 100 changes modes using the mode selection unit 360 (Y in S1603), and the user performs the selected mode display processing (S1604). In this way, the image 1501 of the image display mode is displayed as shown in FIG. 15.

As explained up to this point, it is possible to display images to be looked through by the user in the image display mode.

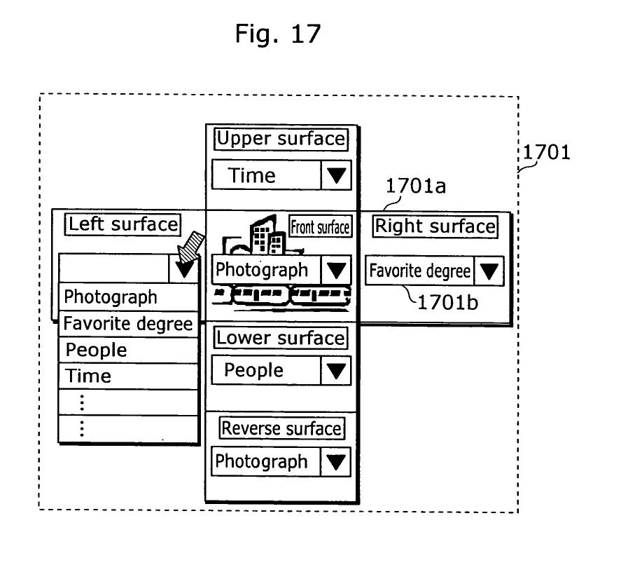

FIG. 17 is a reference diagram of the mobile terminal device 100 concerning the first embodiment in the case of the display information selection mode to be displayed on the display screen. Note that the user inputs or updates pieces of information corresponding to respective surfaces of the block objects displayed in the block display mode or the thumbnail display mode.

On the display screen in the display information selection mode, six illustrations comprising a front view, a rear view, a top plan view, a bottom plan view, a right side view and a left side view of an image object are displayed as a development 1701a, and “selection box 1701b” that enables the user to select pieces of related information concerning the images to be displayed on the respective surfaces is displayed. The user selects pieces of related information to be displayed on the display screen by the selection box 1701b via the enter key input unit 320. Note that pieces of related information here is the same as the one mentioned above, they are, for example, “priority”, “location of image shooting” and the like.

Operations in the display information selection mode will be explained below.

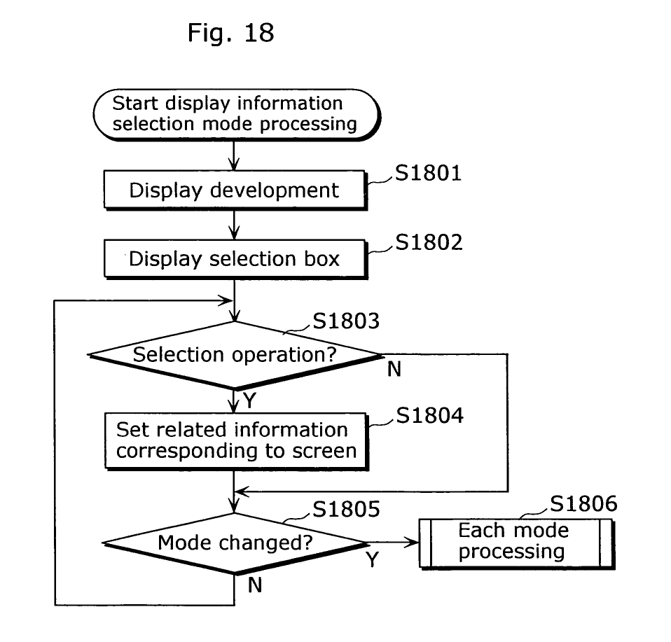

FIG. 18 is a flow chart showing the processing procedure for the mobile terminal device 100 concerning the first embodiment in the case where the display information selection mode is selected.

When the display information selection mode is selected in the mode selection unit 360, the event control unit 400 sends a specification of the development of the block object being specified to the rendering control unit 600 so as to obtain the development from the image storage unit 110. Also, the rendering unit 600 obtains the selection box to be displayed along with the development from the image storage unit 110.

The image generation unit 620 generates images by obtaining the development and the selection box from the rendering control unit 600, and the display unit 630 displays the development and the selection box (S1801 and S1802).

In the display information selection mode, the up and the down by the cursor key input unit 300 mean change of pieces of related information included in the selection box respectively. In the case where the selection operation is performed (Y in S1803), the selected related information is set as the related information corresponding to the surface (S1804).

Next, in the case where the selection operation is not performed (N in S1803) and the user of the mobile terminal device 100 changes modes using the mode selection unit 360 (Y in S1805), the user performs the selected mode display processing (S1806). In this way, the display screen 1701 of the selection information display mode is displayed as shown in FIG. 17.

As explained up to this point, as the user can input and update the block object and the pieces of information corresponding to the respective surfaces of the image objects to be displayed in the display information selection mode concerning the present invention, the user can display favorite information on the respective surfaces of the block object and the image objects.

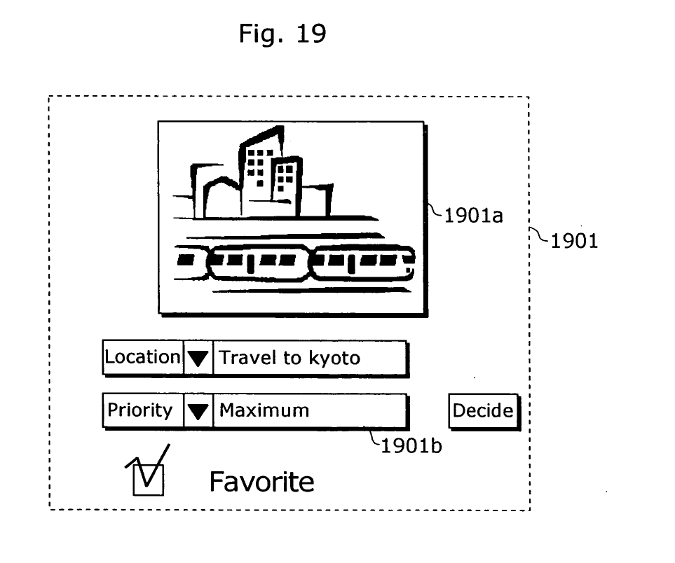

FIG. 19 is a reference diagram of the information input mode displayed on the display screen of the mobile terminal device 100 concerning the first embodiment. On the display screen 1901 of the information input mode, the user can update and input pieces of related information concerning the image object 1901a using the input box 1901b. After that, the pieces of inputted related information are stored in the information storage unit 120.

Operations in the information input mode will be explained below.

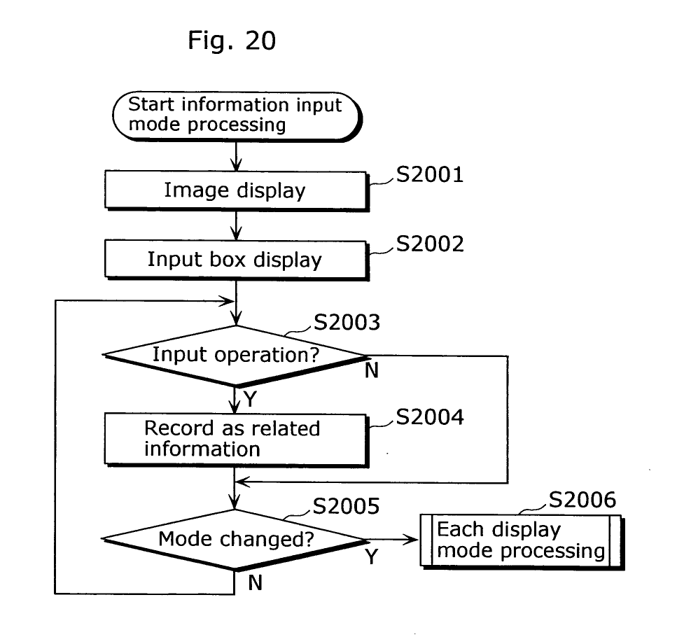

FIG. 20 is a flow chart showing the processing procedure for the mobile terminal device 100 concerning the first embodiment in the case where the information input mode is selected.

When the information input mode is selected in the mode selection unit 360, the event control unit 400 sends a specification of the digital image being specified to the rendering control unit 600 and obtains the image data and the input box from the image storage unit 110.

The image generation unit 620 generates an image by obtaining the image and the input box from the rendering control unit 600, and the display unit 630 displays the development and the input box (S2001 and S2002).

The user performs an operation for inputting the image into the input box via the information input unit 140 (S2003). In the case where the input operation is performed (Y in S2003), the inputted related information is stored in the information storage unit 120 (S2004).

Next, in the case where the input operation is not performed (N in S2003) or the user of the mobile terminal device 100 changes modes using the mode selection unit 360 (Y in S2005), the user performs the selected mode display processing (S2006). In this way, the display screen 1901 in the information input mode is displayed as shown in FIG. 19.

As explained above, in the information input mode concerning the present invention, it is possible to input pieces of related information of the images that are not automatically stored at the time of image shooting based on the Exif format via the information input unit 140, add pieces of favorite related information to the corresponding images and improve the userfriendliness in selecting information.

As explained above, the mobile terminal device 100 concerning the first embodiment comprises a model generation unit 230 that generates objects and an object generation unit 210 that generates image objects by adding digital images and pieces of related information to the objects and block objects by placing these image objects three-dimensionally.

The user of the mobile terminal device 100 can refer to at least two pieces of related information concurrently to the image information displayed in balloons by displaying these three-dimensional block objects on the display screen, and display plural images and the pieces of related information on the small display screen of the mobile terminal in an easy-to-look-through way. Therefore, the user can refer to a lot of information without changing display screens at the time of referring to the images and the various kinds of pieces of related information, which enables to improve image searching efficiency.

Also, as respective kinds of pieces of related information are given a color and the like and added to the corresponding images of a block object, they are displayed on the display screen of the mobile terminal device 100 colorfully, beautifully and interestingly.

As the mobile terminal device 100 has a viewpoint shifting unit 380 for shifting the viewpoint on the object to be displayed, it becomes possible to rotate a block object displayed on the display screen toward a favorite direction and display it. This display method not only increases amusement but also enables a user to search digital images referring to pieces of related information displayed on the other surfaces that are not shown in the initial display screen.

In addition, as the mobile terminal device 100 concerning the first embodiment has an image processing unit 130 for extracting pieces of characteristic information from images, it is possible to extract pieces of characteristic information using face recognition technique, color information, brightness information and the like included in the digital images and stores them in the information storage unit 120 as pieces of related information. Therefore, it becomes possible to give additional pieces of related information to images for the convenience of image searching by a user by displaying pieces of information such as the information on how frequently a specific person appears, the information on whether the photo is shot during daytime or nighttime on the sides of the image objects as texture images.

Also, the mobile terminal device 100 concerning the first embodiment has a texture generation unit operable to generate textures by changing colors, gradation, patterns, shapes and the like based on categories of related information, it is possible to display pieces of related information to be mapped to the block object in an easy-to-look through way.

Also, as the mobile terminal device 100 concerning the first embodiment has a rendering control unit 600 that changes ordering of these image objects based on the pieces of related information, the user can make a block object where image objects are placed based on favorite information such as “time”, “favorite degree” or the like, and thus it is possible to improve searching efficiency. Also, as it is possible to construct a block object by placing image objects in time sequence, even in the case where time flow between images is visualized unlike the conventional thumbnail display method and a large amount of digital images are recorded, it is possible to search images based on time information, for example “photos of night drinking party held two days before”.

In addition, by editing a group of digital images as an album via the key input unit 100c of the mobile terminal device 100 concerning the first embodiment, the user can store the group of images included in the respective albums in respective folders, and display images as a block object for each album in the block display mode.

(Second Embodiment)

Next, the mobile terminal device 100 concerning the second embodiment will be explained. In the second embodiment, image objects displayed on the display screen are placed so that a part of image objects placed toward the backward direction can be recognized as two-dimensional objects not three-dimensional objects. Note that the pieces of related information are added to the peripheral parts of the image objects.

Explanations on the same functional structure and the same operational procedure as the ones for the mobile terminal device 100 in the above-mentioned first embodiment will be omitted in this second embodiment, and explanation on the variation of the ordering method of the image objects displayed on the display screen will be made.

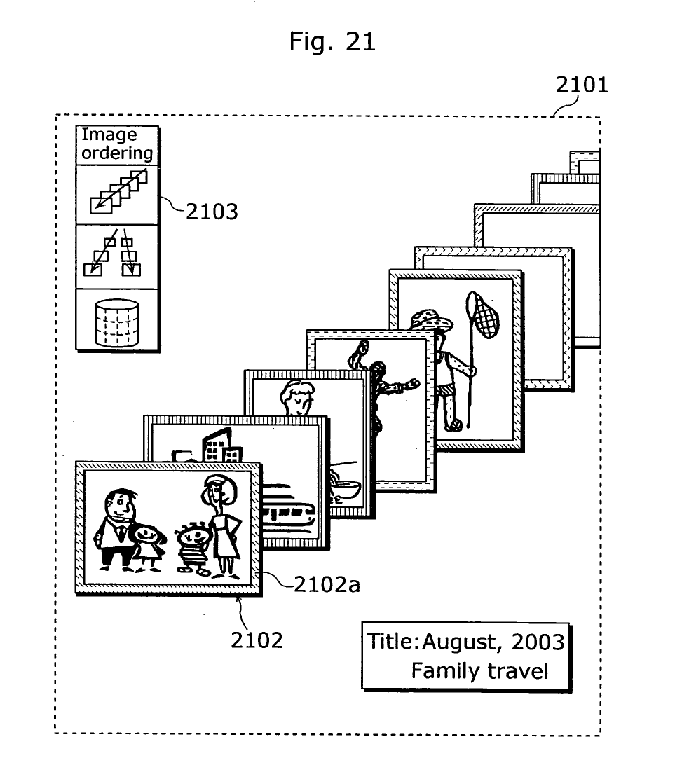

FIG. 21 is a reference diagram showing another display example of the image objects generated in the mobile terminal device 100 concerning the second embodiment.

Two-dimensional image objects 2102 are placed toward the backward direction on the display screen 2101. The object generation unit 210 generates this image object 2101 is generated by mapping texture images stored in the image storage unit 110 onto a two-dimensional board polygon or the like to be generated by the model generation unit 230. Textures that are classified by color, pattern, gradation, shape or the like by the texture generation unit 220 based on pieces of related information are mapped onto the peripheral parts 2101 of the image objects 2102. For example, red texture, green texture and blue texture are mapped onto the peripheral parts of these photos concerning “family”, photos concerning “company”, and photos concerning “travel” respectively.

Therefore, two-dimensional image object 2102 is displayed on the display screen 2101, and photos of image objects 2102 placed toward the backward direction except the most front photo can be confirmed. The peripheral parts 2102a of the image objects 2102 are classified by color or the like based on pieces of related information, which helps a user to select images and makes the display screen 210 look beautiful.

It is possible to display images selected by the user in an outstanding way by shifting the selected image object 2102 upward. Also, the user can easily change ordering methods of the image objects 2102 by making display 2103 for changing image ordering methods.

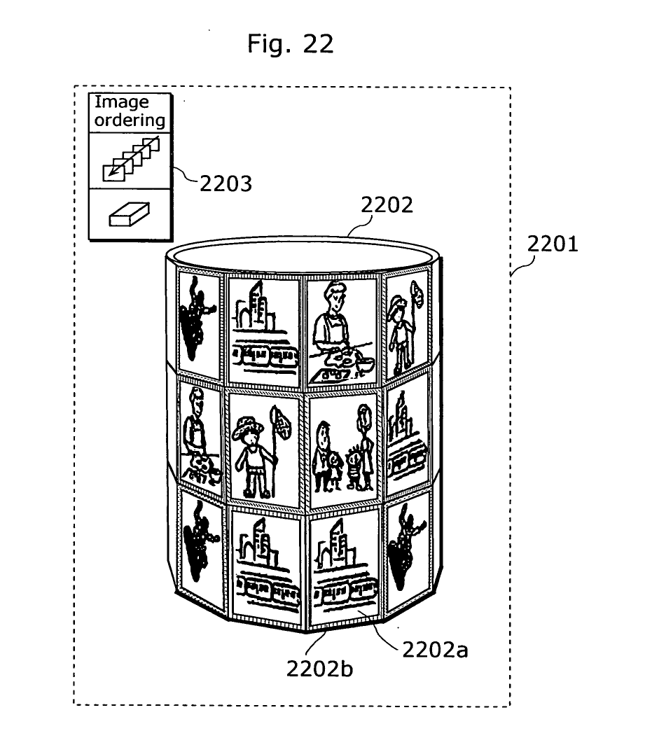

FIG. 22 is a reference diagram showing another display example of image objects by the mobile terminal device 100 concerning the second embodiment.

A cylinder object 2202 is displayed on the display screen 2201, and image objects 2202a are mapped onto the surface of the cylinder object 2202. The peripheral parts 2202b of the respective image objects 2202a are classified by pattern based on pieces of related information.

The user rotates the cylinder object 2202 using the rightward cursor key and the leftward cursor key in the cursor key input unit 300 and selects an image object 2202a using the upward cursor key or the downward cursor key. When selecting ordering by the cylinder object 2202, the image object 2202 in the middle of the row is selected provisionally.

Therefore, the user can select an image object 2202a which is mapped onto the surface by rotating the cylinder object 2202 and realize a display that is enjoyable in selecting images.

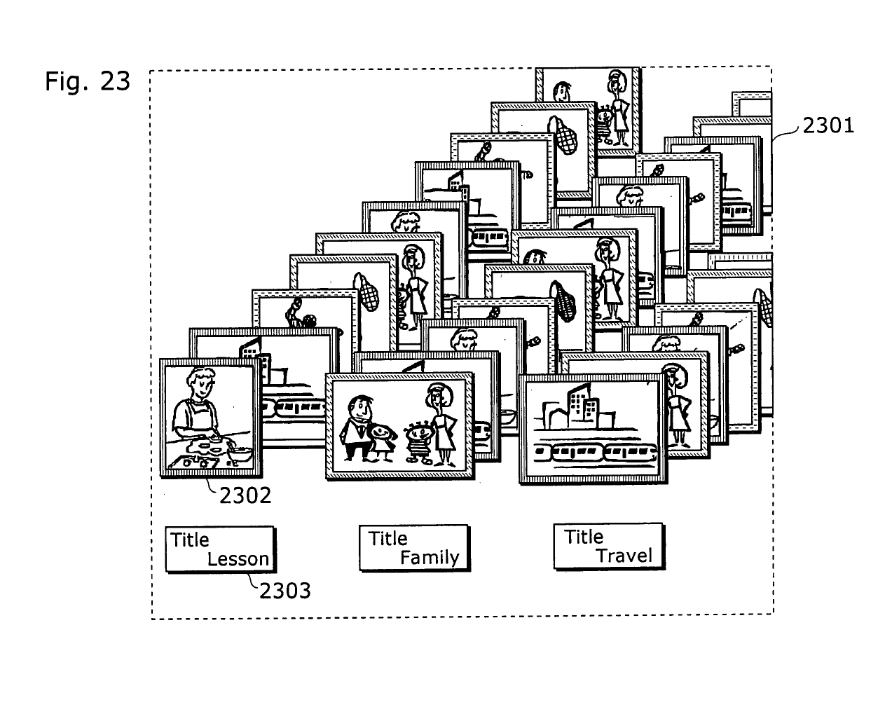

FIG. 23 is a reference diagram showing other display examples of image objects generated by the mobile terminal device 100 concerning the second embodiment.

The user of the mobile terminal device 100 can select a row using the rightward cursor key or the leftward cursor key in the cursor key input unit 300 and an image object 2302 using the upward cursor key or the downward cursor key in this figure. Therefore, a lot of image objects 2302 are displayed on the display screen at once, which improves the efficiency in searching image files. Also, these image objects 2302 are displayed along with pieces of related information that are classified by color, which realizes beautiful display.

Therefore, two-dimensional image object 2102 and the like are displayed on the display screen 2101 and the like of the mobile terminal device 100 concerning the second embodiment, which enables the user to confirm the photos of other image objects 2102 except the most front photo and the like that are placed toward the backward direction and improves the userfriendliness in searching images. Also, pieces of related information that are classified by color are given to the peripheral parts 2102a of the image objects 2102 and the like, which enables the user to select images more easily and realizes beautiful display.

In addition, the user of the mobile terminal device 100 can select an ordering method of favorite image objects 2101 from plural ordering methods, and the display method increases amusement.

As a display mode for the mobile terminal device concerning the above-mentioned embodiments, an ordering method selection mode that enables a user to select an ordering method of digital images may be set.

In this ordering method selection mode, ordering methods of these image objects to be displayed on the display screen can be displayed according to the previously set ordering. These ordering methods include ordering in a form of block objects to be displayed on the display screen of the mobile terminal device 100 concerning the first embodiment, ordering in a form of two-dimensional objects concerning the second embodiment and the like.

Therefore, the user of the mobile terminal device 100 can select ordering method of image objects displayed on the display screen by using the ordering method selection mode.

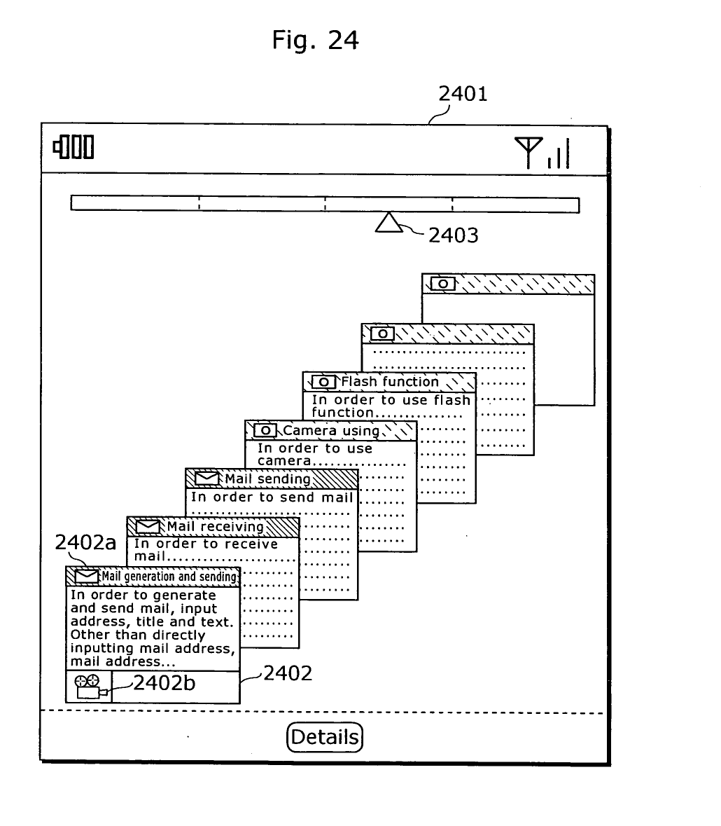

FIG. 24 is a reference diagram showing other display examples of the image objects of the mobile terminal device 100 concerning the second embodiment. In the display example shown in this FIG. 24, pieces of help information of the mobile telephones as two-dimensional objects are displayed three-dimensionally.

On the display screen 2401, pieces of help information of the mobile telephone are displayed as a single two-dimensional object for each type, outlines of the pieces of help information are displayed on the front surface of the respective two-dimensional objects as character information and a piece of help information with a piece of color information that indicates a category classified by color is displayed on each frame 2402a, for example, a piece of help information concerning mail is displayed in red, while a piece of help information concerning mobile cameras is displayed in green.

Respective two-dimensional objects 2402 are placed three-dimensionally toward the diagonal direction so that a part of the pieces of information of the two-dimensional objects 2402 that are placed backward can be recognized. This enables the user to recognize a part of pieces of help information that are placed backward in the same display screen, and search pieces of help information more easily.

In addition, for example, the user can refer to pieces of the downloaded help information in a form of a moving image by selecting the camera mark 2402b displayed in the lower row of the two-dimensional object 2402. Also, the cursor 2403 placed at an upper point on the display screen 2401 shows the position in all the pieces of help information.

Also, it is assumed that digital images are displayed on the display screen in the above explanations of these embodiments, but this present invention is not limited to this. For example, digital moving images may be displayed as a block object, and in this case, the depth of the three-dimensional object can be displayed in proportion to the data amount of the digital moving images.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The mobile terminal device concerning the present invention relates to an image display device with a function for displaying images, and is applicable especially for mobile phones, PDAs, car navigation devices and the like which have a small display screen.

1. A mobile terminal device comprising:
an object generation unit operable to generate an object;
a texture generation unit operable to generate a second texture image for a piece of related information relating to a first texture image;
a texture mapping unit operable to map the first texture image, and the second texture image generated by the texture generation unit, onto the object generated by the object generation unit so as to generate an image object;
a block object generation unit operable to generate a block object by placing a plurality of image objects in three-dimensional space based on corresponding pieces of related information so as to generate a block object;
an image generation unit operable to generate an image of the block object; and
a display unit operable to display the image generated by the image generation unit.

2. The mobile terminal device according to claim 1,
wherein the object generation unit generates a two-dimensional object,
the texture mapping unit generates image objects by mapping the first texture image onto a front surface of the two-dimensional object, and the second texture image onto a portion or a whole of peripheral part of the two-dimensional object,
the block generation unit generates a block object by placing two-dimensional image objects in a diagonal direction in the three-dimensional space based on pieces of related information so that at least a part of image objects placed backward can be recognized,
the image generation unit generates images of the block objects, and
the display unit displays the images.

3. The mobile terminal device according to claim 2,
wherein the first texture images include character information, and the second texture images include pieces of color information that are classified into categories of the first texture images.

4. The mobile terminal device according to claim 1,
wherein the object generation unit generates a three-dimensional object,
the texture mapping unit generates image objects by mapping the first texture image onto front surfaces of the three-dimensional object, the second texture image onto a side surface of the three-dimensional objects,
the block generation unit generates a block object by placing the plurality of the image objects based on the pieces of related information so that the image objects construct a polyhedron in the three-dimensional space,
the image generation unit generates images of the block object, and
the display unit displays the images.

5. The mobile terminal device according to claim 1,
wherein the texture generation unit generates the second texture images for classifying the pieces of related information of the first texture images into some categories by color, pattern, gradation or shape.

6. The mobile terminal device according to claim 1, further comprising:
an image storage unit operable to store the first texture images; and
an information storage unit operable to store position information on where the pieces of related information and the block object are placed,
wherein, the image generation unit generates images of the block object based on the position information.

7. The mobile terminal device according to claim 1,
wherein the pieces of related information include at least one of (i) a piece of information concerning images: time of image generating; time of image shooting; a date; recording duration; an image size; brightness; and a color, and (ii) a piece of information concerning details of image shooting and help information for the mobile terminal device: a location of image shooting; a favorite degree; a genre; and a reference frequency,
the mobile terminal device further comprises
an ordering change unit operable to change ordering of the image objects based on the pieces of related information, and
the block generation unit generates a block object by placing the image objects in the three-dimensional space based on the change made by the ordering change unit.

8. The mobile terminal device according to claim 1, further comprising:
a viewpoint shifting unit operable to arbitrarily shift a viewpoint on a display screen according to an input from a user; and
a position information generation unit operable to generate position information from the viewpoint after shifting by the viewpoint shifting unit,
wherein the image generation unit generates images of the block object based on the position information after shifting, and
the display unit displays the images.

9. The mobile terminal device according to claim 1, further comprising an extraction unit operable to extract feature information indicating features of images from the first texture images,
wherein the feature information includes at least one of: information on people in an image; information on color used in an image; and information on brightness used in an image.

10. The mobile terminal device according to claim 9,
wherein the extraction unit records the feature information in the information storage unit as related information.

11. The mobile terminal device according to claim 1, further comprising:
a cursor key input unit operable to shift a position of a cursor displayed on a display screen to a position desired by a user according to an instruction from the user;
an enter key input unit operable to select the image object on which the cursor is placed; and
a decision unit operable to decide whether the image object selected by the enter key input unit should be selected or not.

12. The mobile terminal device according to claim 1,
wherein the block generation unit generates a block object by placing a group of image objects related to each other as an album in the three-dimensional space based on the pieces of related information,
the image generation unit generates at least one block object corresponding to the album, and
the display unit displays the images.

13. The mobile terminal device according to claim 1,
wherein the object generation unit further generates:
(a) a cursor object that is an arrow displayed on a display screen;
(b) a frame cursor object indicating a viewpoint on the block object;
(c) an axis object that is an arrow indicating time information of the block object; and
(d) a balloon object including a thumbnail image of the image object indicated by the cursor object.

14. The mobile terminal device according to claim 1, further comprising
a mode selection unit operable to select a display mode from a plurality of display modes for the three-dimensional object,
wherein the image generation unit generates images by placing the image object, the block object, the cursor object, the frame cursor object, the axis object, or the balloon object in the three-dimensional space depending on display modes,
the display unit displays the images.

15. The mobile terminal device according to claim 14,
wherein the display mode is one of:
(a) a block display mode where one or more block objects that are classified into a group are placed in the three-dimensional space;
(b) a thumbnail display mode where images of a block object can be searched by shifting a cursor object via the cursor key input unit;
(c) an image display mode where the first texture images are displayed;
(d) an information input mode where pieces of information concerning the block object and the image object are inputted; and
(e) a display information selection mode where pieces of information are displayed on respective surfaces of a block object.

16. The mobile terminal device according to claim 15,
wherein, in the case where the thumbnail display method is selected by the mode selection unit, the image generation unit generates images by placing the block object, the cursor object, the frame cursor object, the balloon object, the image object and the axis object in the three-dimensional space based on position information.

17. The mobile terminal device according to claim 15,
wherein, in the case where the block display mode is selected by the mode selection unit, the image generation unit generates one of (i) an image where the plurality of block objects and the cursor object are placed in the three-dimensional space and (ii) an image where one of the plurality of block objects is placed, and the image to be displayed is changed one after another by the cursor key input unit.

18. The mobile terminal device according to claim 15,
wherein, in the case where the image display mode is selected by the mode selection unit, the display unit displays the first texture images entered by the enter key input unit on the display screen.

19. The mobile terminal device according to claim 15, further comprising
an information input unit operable to obtain information from a user concerning the first texture images,
wherein, in the case where the information input mode is selected in the mode selection unit, the display unit displays the first texture images entered by the enter key input unit and an input box where information is inputted by the information input unit.

20. The mobile terminal device according to claim 15,
wherein, in the case where the display information selection mode is selected by the mode selection unit, the display unit displays a development of the image object entered by the enter key input unit and a display information selection box for selecting display information on the display screen.

21. The mobile terminal device according to claim 1,
wherein the block generation unit generates the block object by placing the image objects on the block object that is cylindrical.

22. The mobile terminal device according to claim 1, further comprising
a second texture mapping unit operable to generate moving image objects by mapping digital moving images and pieces of related information of the digital moving images onto the objects.

23. An image display method comprising:
an object generation step of generating an object;
a texture generation step of generating a second texture image for a piece of related information relating to a first texture image;
a texture mapping step of mapping the first texture image and the second texture image generated in the texture generation step onto the object generated in the object generation step so as to generate an image object;
a block generation step of placing a plurality of two dimensional image objects in the three-dimensional space based on the pieces of related information so as to generate a block object;
an image generation step of generating images of the block object; and
a display step of displaying images generated in the image generation step.

24. The image display method according to claim 23,
wherein, in the object generation step, a two-dimensional object is generated,
in the texture mapping step, image object is generated by mapping the first texture image onto front surface of the two-dimensional object, and the second texture image onto a portion or a whole of peripheral part of the two-dimensional object,
in the block generation step, a block object is generated by placing the plurality of the two-dimensional image objects in a diagonal direction in the three-dimensional space based on the pieces of related information so that at least a part of the image objects placed backward can be recognized,
in the image generation step, images of the block object are generated, and
in the display step, the images are displayed.

25. The image display method according to claim 23,
wherein, in the object generation step, a three-dimensional object is generated,
in the texture mapping step, an image object is generated by mapping the first texture image onto front surface of the three-dimensional object, the second texture image on side surface of the three-dimensional object,
in the block generation step, a block object is generated by placing the image objects in the three-dimensional space based on the pieces of related information so that the image objects can construct a polyhedron,
in the image generation step, images of the block object are generated, and
in the display step, the images are displayed.

26. A program causing a computer to execute following steps:
an object generation step of generating an object;
a texture generation step of generating second texture image for a piece of related information relating to a first texture image;
a texture mapping step of generating an image object by mapping the first texture image and the second texture image generated in the texture generation step onto the object generated in the object generation step;
a block generation step of generating a block object by placing a plurality of the image objects in the three-dimensional space based on the pieces of related information;
an image generation step of generating images of the block object; and
a display step of displaying images generated in the image generation step.

27. A program according to claim 26,
wherein, in the object generation step, a two-dimensional object is generated,
in the texture mapping step, an image object is generated by mapping the first texture image onto front surface of the two-dimensional object, the second texture image onto a portion of or a whole peripheral part of the two-dimensional object,
in the block generation step, a block object is generated by placing a plurality of the two-dimensional block objects in a diagonal direction in the three-dimensional space based on the pieces of related information so that at least a part of image objects placed backward can be recognized,
in the image generation step, images of the block object are generated, and
in the display step, the images are displayed.

28. A program according to claim 26, comprising:
an object generation step where a three-dimensional object is generated;
a texture mapping step where an image object is generated by mapping the first texture image onto front surface of the three-dimensional object, the second texture image on side surface of the three-dimensional object;
a block generation step where block objects are generated by placing image objects in the three-dimensional space based on the pieces of related information so that the image objects can construct a polyhedron;
an image generation step where images of the block object are generated; and
a display step where the images are displayed.

29. The mobile terminal device according to claim 2, further comprising:
an image storage unit operable to store the first texture images; and
an information storage unit operable to store position information on where the pieces of related information and the block object are placed,
wherein, the image generation unit generates images of the block object based on the position information.

30. The mobile terminal device according to claim 4, further comprising:
an image storage unit operable to store the first texture images; and
an information storage unit operable to store position information on where the pieces of related information and the block object are placed,
wherein, the image generation unit generates images of the block object based on the position information.
